(19) United States
(12) Patent Application Publication
(10) Pub. No.: US 2017/0156324 A1
(43) Pub. Date: Jun. 8, 2017

(54) HERBICIDAL COMPOSITIONS CONTAINING 4-AMINO-3-CHLORO-6-(4-CHLORO-2-FLUORO-3-METHOXYPHENYL)PYRIDINE-2-CARBOXYLIC ACID OR DERIVATIVE THEREOF, FLORASULAM OR DERIVATIVE THEREOF, AND PYROXSULAM OR DERIVATIVE THEREOF

(71) Applicant: Dow AgroSciences LLC, Indianapolis, IN (US)

(72) Inventors: Roger E. Gast, Indianapolis, IN (US); Richard K. Mann, Indianapolis, IN (US)

(73) Assignee: Dow AgroSciences LLC, Indianapolis, IN (US)

(21) Appl. No.: 15/367,587

(22) Filed: Dec. 2, 2016

Related U.S. Application Data
(60) Provisional application No. 62/264,519, filed on Dec. 8, 2015.

(51) Int. Cl. A01N 43/40; A01N 43/42; A01N 43/90

(52) U.S. Cl. CPC A01N 43/40; A01N 43/90; A01N 43/42

(57) ABSTRACT

Provided herein are herbicidal compositions and methods using a mixture comprising (a) the compound of formula (I)

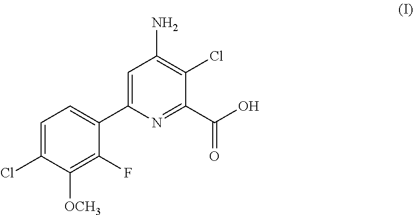 [SMILES: COc1c(Cl)ccc(-c2cc(N)c(Cl)c(C(=O)O)n2)c1F]

or an agriculturally acceptable salt of ester thereof, (b) florasulam or an agriculturally acceptable salt thereof, and (c) pyroxsulam or an agriculturally acceptable salt thereof. The compositions provide synergistic weed control of undesirable vegetation in areas including, but not limited to, annual crop, cereal crop, fallow-bed, non-crop, IVM, range and pasture, tree and vine crop, perennial crop, fruiting crop, and plantation crop areas.

### BACKGROUND

The protection of crops from weeds and other vegetation which inhibit crop growth is a recurring problem in agriculture. To help combat this problem, a variety of chemicals and chemical formulations effective in the control of such unwanted vegetation have been synthesized and evaluated. Different classes of chemical herbicides have been disclosed in the literature and a large number are in commercial use. However, there remains a need for improved compositions and methods of use thereof that are effective in controlling undesirable vegetation.

### SUMMARY

Provided herein are herbicidal compositions comprising a herbicidally effective amount of (a) a compound of the formula (I)

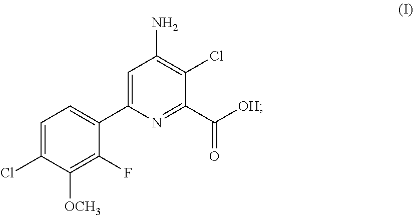 [SMILES: COc1c(Cl)ccc(-c2cc(N)c(Cl)c(C(=O)O)n2)c1F]

or an agriculturally acceptable salt or ester thereof, (b) florasulam or an agriculturally acceptable salt thereof, and (c) pyroxsulam or an agriculturally acceptable salt thereof. The compositions may also contain one or more agriculturally acceptable safeners, adjuvants and/or carriers. In some embodiments, the mixtures are synergistic or exhibit synergy as determined by the Colby Equation.

The three-way mixture can be prepared as a tank mix or premix. For example, a tank mix or premix containing the compound of formula (I) or a salt or ester thereof and florasulam or a salt thereof can bmixed with pyroxsulam or salt thereof to form the three-component tank mix. In this embodiment, the tank mix, co-pack, premix or concentrate of the compound of formula (I) and florasulam and pyroxsulam can be packaged and sold separately, can be co-packaged together in separate single or multiple containers or can be formulated together in one package.

In other embodiments, a premix or concentrate containing the compound of formula (I) or a salt or ester thereof and pyroxsulam or a salt thereof can be mixed in a tank or container with florasulam or a salt thereof to form the tank mix. In this embodiment, the premix or concentrate of the compound of formula (I) and pyroxsulam and the florasulam can be packaged and sold separately, or can be co-packaged together in separate containers, or can be formulated together in one package.

In still other embodiments, a premix containing all three active ingredients can be prepared and sold.

The ratio of the compound of formula (I) to florasulam in the premix is from about 1:120 to 80:1; from about 1:15 to 10:1, and from about 1:2.1 to about 2:1. The ratio of the compound of formula (I) to florasulam to pyroxsulam in the tank mix or premix is from about 1-80 to about 1-120 to about 1-200; from about 1-10 to about 1-15 to about 1-25; and from about 1-2 to about 1-2.1 to about 1-4.

In another embodiment, methods of controlling undesirable vegetation in cereal crops (wheat, barley, oats, rye, teff, triticale and rice), corn/maize, sorghum, sunflower, soybean, cotton, non-crop (turf, tree and ornamentals), fallow, fallow-bed, range and pasture, forestry, perennial crops, tree and vine crops (vineyards, olive, citrus, tree nut (almond, walnut, pecan or pistachio), pome and stone, fruiting crops, or plantation crop (palm oil, rubber, coffee or cacao) areas including contacting the undesirable vegetation or the locus thereof, including but not limited to foliage, soil or water, with a composition containing a herbicidally effective amount of (a) a compound of formula (I) or an agriculturally acceptable ester or salt thereof, (b) florasulam or an agriculturally acceptable salt thereof, and (c) pyroxsulam or an agriculturally acceptable salt thereof are described herein. In some embodiments, the mixtures are synergistic or exhibit synergy as determined by the Colby Equation.

### DETAILED DESCRIPTION

### I. Definitions

As used herein, control of or controlling undesirable vegetation means killing or preventing the growth of the vegetation, or causing some other adversely modifying effect to the vegetation e.g., necrosis, chlorosis, stunting, deviations from natural growth or development, regulation, desiccation, retardation, and the like.

As used herein, herbicide and herbicidal active ingredient mean a compound that controls undesirable vegetation when applied in an appropriate amount.

As used herein, a herbicidally effective or vegetation controlling amount is an amount of herbicidal active ingredient the application of which controls the relevant undesirable vegetation.

As used herein, applying a herbicide or herbicidal composition means delivering it directly to the targeted vegetation or to the locus thereof or to the area where control of undesired vegetation is desired. Methods of application include, but are not limited to pre-emergence, post-emergence, foliar, soil, and in-water applications. Described herein are methods of controlling undesirable vegetation by applying certain herbicide combinations or compositions.

As used herein, plants and vegetation include, but are not limited to, dormant seeds, germinant seeds, emerging seedlings, plants emerging from vegetative propagules, immature vegetation, mature vegetation, reproductive vegetation and established vegetation.

As used herein, immature vegetation refers to small vegetative plants prior to reproductive stage, and mature vegetation refers to vegetative plants during and after reproductive stage.

As used herein, herbicide tolerant cereals (wheat, barley, oats, teff, rye and rice), corn or sorghum refer to crops that are genetically modified to be tolerant to various herbicides, including cereal crops that are genetically modified to be tolerant to acetolactate synthase (ALS), acetyl CoA carboxylase (ACCase), 2,4-D, dicamba, HPPD, PPO, glyphosate and glufosinate mode of action herbicides. Examples of 2,4-D tolerant cereals, corn or sorghum include crops containing the aad-1 gene which confers tolerance to 2,4-D (U.S. Pat. No. 7,838,733 B2).

As used herein, glyphosate tolerance refers to cereals (wheat, barley, oats, teff, rye and rice), corn or sorghum that are genetically modified to be tolerant to glyphosate. Glyphosate tolerance can be provided, for example, by the CP4 gene (U.S. Pat. No. 5,627,061 A) or 2mEPSPS (U.S. Pat. No. 6,566,587 B1) as shown herein; however, glyphosate tolerance could also be conferred within the scope of glyphosate-, 2,4-D-, and glufosinate-tolerant-cereals (wheat, barley, oats, teff, rye and rice), corn or sorghum described herein by other genes providing transgenic crop tolerance to glyphosate [e.g., AroA and other Class II EPSPS (U.S. Pat. No. 7,893,234 B2); GLG23 and other Class III EPSPS (U.S. Pat. No. 7,700,842 B2); GAT (U.S. Pat. No. 7,405,074 B2), Gox (U.S. Pat. No. 5,463,175 A), or other glyphosate-metabolism gene; or DGT-28 or other Class IV EPSPS (U.S. Patent Application Publication 20130217577A1)] and are considered to be included within the scope of the 2,4-D-, glyphosate- and glufosinate-tolerant cereals (wheat, barley, oats, teff, rye and rice), corn or sorghum described herein.

As used herein, glufosinate tolerance refers to cereals (wheat, barley, oats, teff, rye and rice), corn or sorghum that are genetically modified to be tolerant to glufosinate. Glufosinate tolerance can be provided, for example, by the pat gene (U.S. Pat. No. 5,276,268 B2) as shown herein; however, glufosinate tolerance could also be conferred within the scope of the 2,4-D- and glufosinate-tolerant cereals (wheat, barley, oats, teff, rye and rice), corn or sorghum described herein by other genes providing transgenic crop tolerance to glufosinate [e.g., bar (U.S. Pat. No. 5,561,236 A) and dsm2 (PCT International Application WO2008070845)].

### II. Mixtures

Compositions containing the compound of formula (I) or a salt or ester thereof, florasulam or a salt thereof, and pyroxsulam or a salt thereof are described herein. The composition can be in the form of a tank mix, premix, co-pack or a tank mix of one or more compositions mixed with one or more separate compositions containing the compound of formula (I) or a salt or ester thereof, florasulam or a salt thereof, and pyroxsulam or a salt thereof. The tank mix can be prepared by mixing a premix, co-pack or tank mix or concentrate containing the compound of formula (I) and florasulam or pyroxsulam. Agriculturally acceptable salts and esters refer to salts and esters that exhibit herbicidal activity, or that are or can be converted in plants, water, or soil to the referenced herbicide. Exemplary agriculturally acceptable esters are those that are or can by hydrolyzed, oxidized, metabolized, or otherwise converted, e.g., in plants, water, or soil, to the corresponding carboxylic acid which, depending on the pH, may be in the dissociated or undissociated form. Exemplary salts include those derived from alkali or alkaline earth metals and those derived from ammonia and amines Exemplary cations include sodium, potassium, magnesium, and ammonium cations of the formula:

R¹R²R³R⁴N⁺

wherein R¹, R², R³ and R⁴ each, independently represents hydrogen or C₁-C₁₂ alkyl, C₃-C₁₂ alkenyl or C₃-C₁₂ alkynyl, each of which is optionally substituted by one or more hydroxy, C₁-C₄ alkoxy, C₁-C₄ alkylthio or phenyl groups, provided that R¹, R², R³ and R⁴ are sterically compatible. Additionally, any two of R¹, R², R³ and R⁴ together may represent an aliphatic difunctional moiety containing one to twelve carbon atoms and up to two oxygen or sulfur atoms. Salts can be prepared by treatment with a metal hydroxide, such as sodium hydroxide, with an amine, such as ammonia, trimethylamine, diethanolamine, 2-methylthiopropylamine, bisallylamine, 2-butoxyethylamine, morpholine, cyclododecylamine, or benzylamine or with a tetraalkylammonium hydroxide, such as tetramethylammonium hydroxide or choline hydroxide.

Exemplary esters include those derived from C₁-C₁₂ alkyl, C₃-C₁₂ alkenyl, C₃-C₁₂ alkynyl or C₇-C₁₀ aryl-substituted alkyl alcohols, such as methyl alcohol, isopropyl alcohol, 1-butanol, 2-ethylhexanol, butoxyethanol, methoxypropanol, allyl alcohol, propargyl alcohol, cyclohexanol or unsubstituted or substituted benzyl alcohols. Benzyl alcohols may be substituted with from 1-3 substituents independently selected from halogen, C₁-C₄ alkyl or C₁-C₄ alkoxy. Esters can be prepared by coupling of the acids with the alcohol using any number of suitable activating agents such as those used for peptide couplings such as dicyclohexylcarbodiimide (DCC) or carbonyl diimidazole (CDI); by reacting the acids with alkylating agents such as alkylhalides or alkylsulfonates in the presence of a base such as triethylamine or lithium carbonate; by reacting the corresponding acid chloride of an acid with an appropriate alcohol; by reacting the corresponding acid with an appropriate alcohol in the presence of an acid catalyst or by transesterification.

Weight ratios of mixtures are calculated using the acid equivalent weight(s) of any compounds in the mixture that are salts or esters. Weight ratios are expressed in units of weight to weight (grams (g) to g), grams acid equivalent per hectare (g ae/ha) to g ae/ha), grams acid equivalent per hectare (g ae/ha) to grams active ingredient per hectare (g ai/ha), or grams active ingredient per hectare (g ai/ha) to g ai/ha).

The combination of the compound of formula (I) or agriculturally acceptable salt or ester thereof, florasulam or agriculturally acceptable salt thereof, and pyroxsulam or agriculturally acceptable salt thereof can exhibit synergism, i.e., the herbicidal active ingredients are more effective in combination than when applied individually. As defined in the Herbicide Handbook of the Weed Science Society of America, Tenth Edition, 2014, p. 487, “‘Synergism [is] an interaction of two or more factors such that the effect when combined is greater than the predicted effect based on the response of each factor applied separately.” In certain embodiments, the compositions exhibit synergy as determined by Colby's equation as described in Colby, S. R. Calculation of the synergistic and antagonistic response of herbicide combinations. Weeds 1967, 15, 20-22.

A. Halauxifen

The compound of formula (I) has the following structure:

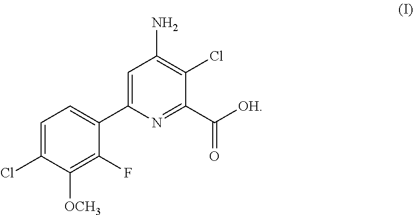 [SMILES: COc1c(Cl)ccc(-c2cc(N)c(Cl)c(C(=O)O)n2)c1F]

The compound of formula (I) can be identified by the name 4-amino-3-chloro-6-(4-chloro-2-fluoro-3-methoxyphenyl)pyridine-2-carboxylic acid and and has been described in U.S. Pat. No. 7,314,849 (B2), which is incorporated herein by reference in its entirety. It is also referred to as halauxifen. The methyl ester is known as halauxifen-methyl and is sold commercially as ARYLEX® active.

In certain embodiments of the compositions and methods described herein, the compound of formula (I), i.e., the carboxylic acid, is employed. In certain embodiments, a carboxylate salt of the compound of formula (I) is employed. In certain embodiments, an arylalkyl or alkyl ester is employed. In certain embodiments, a benzyl, substituted benzyl, or C₁-C₄ alkyl, e.g., methyl or n-butyl ester is employed. In certain embodiments, the methyl ester, benzyl ester, or potassium salt is employed.

Exemplary uses of of the compound of the formula (I) include controlling undesirable vegetation, including e.g. grass, broadleaf, and sedge weeds, in multiple crop and non-crop situations.

B. Florasulam

Florasulam is a triazolopyrimidine sulfonamide having the structure below:

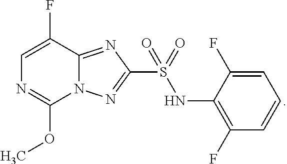 [SMILES: COc1ncc(F)c2nc(S(=O)(=O)Nc3c(F)cccc3F)nn12]

Triazolopyrimidine sulfonamides are a chemical class of herbicides having a triazolopyrimidine sulfonamide core structure. Their mode-of-action is believed to involve the inhibition of acetolactate synthase (ALS), an enzyme common to plants and microorganisms but not found in animals. Exemplary herbicidal uses of triazolopyrimidine sulfonamides include, but are not limited to, use for control of nuisance sedge, broadleaf, and grass weeds in multiple crops and turf.

Florasulam is N-(2,6-difluorophenyl)-8-fluoro-5-methoxy[1,2,4]triazolo[1,5-c]pyrimidine-2-sulfonamide and has the following structure. Its herbicidal activity is exemplified in Tomlin, C. D. S., Ed. The Pesticide Manual: A World Compendium, 15^{th} ed.; BCPC: Alton, 2009 (hereafter “The Pesticide Manual, Fifteenth Edition, 2009”). Exemplary uses of florasulam include, but are not limited to, its use as a herbicide in post-emergence control of broadleaf weeds in cereals, maize and turf.

C. Pyroxsulam

Pyroxsulam is is a triazolopyrimidine sulfonamide having the structure below:

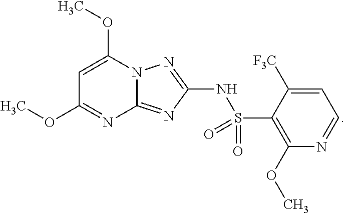 [SMILES: COc1cc(OC)n2nc(NS(=O)(=O)c3c(C(F)(F)F)ccnc3OC)nc2n1]

Pyroxsulam is N-(5,7-dimethoxy[1,2,4]triazolo[1,5-a]pyrimidin-2-yl)-2-methoxy-4-(trifluoromethyl)-pyridine-3-sulfonamide and possesses the following structure. Its herbicidal activity is exemplified in The Pesticide Manual, Fifteenth Edition, 2009. Exemplary uses of pyroxsulam include its use as a herbicide for broad spectrum post-emergence control of annual grass and broadleaf weeds in cereals.

### III. Tank Mixes, Pre-Mixes and Co-Packs

Tank mixes, pre-mixes and co-packs containing the compound of formula (I) or a salt or ester thereof, florasulam or a salt thereof, and pyroxsulam or a salt thereof are described herein. In some embodiments, the tank mix is prepared by mixing a premix of the compound of formula (I) or a salt or ester thereof and florasulam or a salt thereof with a concentrate containing pyroxsulam or a salt thereof. In other embodiments, the tank mix is prepared by mixing the compound of formula (I) or a salt or ester thereof and pyroxsulam or a salt thereof with florsulam or a salt thereof. In still other embodiments, the premix or co-pack contains all three active ingredients which is diluted prior to use/application. The premix or suitable pre-mixes can contain one or more suitable adjuvants, safeners and/or carriers.

In some embodiments, compositions provided herein further comprise at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water-dispersible granules, microcapsules or wettable powders, or liquids, such as, for example, emulsifiable concentrates, solutions, emulsions or suspensions. They can also be provided as a pre-mix or tank mixed.

Suitable agricultural adjuvants and carriers include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99.

Liquid carriers that can be employed include water and organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. In certain embodiments, water is the carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, cellulose, and the like.

In some embodiments, the compositions described herein further comprise one or more surface-active agents. In some embodiments, such surface-active agents are employed in both solid and liquid compositions, and in certain embodiments those designed to be diluted with carrier before application. The surface-active agents can be anionic, cationic or nonionic in character and can be employed as emulsifying agents, wetting agents, suspending agents, or for other purposes. Surfactants which may also be used in the present formulations are described, inter alia, in McCutcheon's Detergents and Emulsifiers Annual, MC Publishing Corporation: Ridgewood, N J, 1998 and in Encyclopedia of Surfactants, Vol. I-III, Chemical Publishing Company: New York, 1980-81. Surface-active agents include, but are not limited to salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

In some embodiments, these materials, such as vegetable or seed oils and their esters, can be used interchangeably as an agricultural adjuvant, as a liquid carrier or as a surface active agent.

Other exemplary additives for use in the compositions provided herein include but are not limited to compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

The tank mixes described herein can further contain one or more additional herbicides. The herbicides can be incorporated into the one or more of the pre-mixes, tank mixes or concentrates or can be added at the time the tank mix is prepared by formulation or prior to application. When used in conjunction with other herbicides, the composition can be formulated with the other herbicide or herbicides, tank-mixed with the other herbicide or herbicides or applied sequentially with the other herbicide or herbicides. Some of the herbicides that can be employed in conjunction with the compositions and methods described herein include, but are not limited to acid, salt and ester forms of the following herbicides: 4-CPA, 4-CPB, 4-CPP, 3,4-DA, 2,4-D esters and salts, 2,4-DB, 3,4-DB, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, bentazon, benthiocarb, benzadox, benzfendizone, benzipram, benzobicyclon, benzofenap, benzofluor, benzoylprop, benzthiazuron, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone (e.g., carfentrazone-ethyl), CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon (e.g., cinidon-ethyl), cinmethylin, cinosulfuron, cisanilide, clethodim, cliodinate, clodinafop-propargyl, clofop, clomazone, clomeprop, cloprop, cloproxydim, clopyralid, cloransulam-methyl, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop (e.g., cyhalofop-butyl), cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethbenzamide, ethalfluralin, ethametsulfuron, ethidimuron, ethiolate, ethobenzamid, etobenzamid, ethofumesate, ethoxyfen, ethoxysulfuron, etinofen, etnipromid, etobenzanid, EXD, fenasulam, fenoprop, fenoxaprop (e.g., fenoxaprop-P-ethyl), fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, flazasulfuron, fluazifop (e.g., fluazifop-P-butyl), fluazolate, flucarbazone, flucetosulfuron, fluchloralin, flufenacet, flufenican, flufenpyr (e.g., flufenpyr-ethyl), flumetsulam, flumezin, flumiclorac (e.g., flumiclorac-pentyl), flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, flurtamone, fluthiacet, fomesafen, foramsulfuron, fosamine, fumiclorac, furyloxyfen, glufosinate, glyphosate, halosafen, halosulfuron (e.g., halosulfuron-methyl), haloxydine, haloxyfop-methyl, haloxyfop-P (e.g., haloxyfop-P-methyl), hexachloroacetone, hexaflurate, hexazinone, imazamethabenz, imazamox, imazapic, imazapyr, imazaquin, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, metsulfuron-methyl, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, paraflufen-ethyl, parafluron, paraquat, pebulate, pelargonic acid, pendimethalin, penoxsulam, pentachlorophenol, pentanochlor, pentoxazone, perfluidone, pethoxamid, phenisopham, phenmedipham (e.g., phenmedipham-ethyl), phenobenzuron, phenylmercury acetate, picloram, picolinafen, pinoxaden, piperophos, potassium arsenite, potassium azide, potassium cyanate, pretilachlor, primisulfuron (e.g., primisulfuron-methyl), procyazine, prodiamine, profluazol, profluralin, profoxydim, proglinazine, prohexadione-calcium, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen (e.g., pyraflufen-ethyl), pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfuron-methyl, thiobencarb, tiafenacil, tiocarbazil, tioclorim, topramezone, tolpyralate, tralkoxydim, triafamone, tri-allate, triasulfuron, triaziflam, tribenuron (e.g., tribenuron-methyl), tricamba, triclopyr (e.g., triclopyr choline salt), triclopyr esters and salts, tridiphane, trietazine, trifloxysulfuron, trifludimoxazin, trifluralin, triflusulfuron, trifop, trifopsime, trihydroxytriazine, trimeturon, tripropindan, tritac tritosulfuron, vernolate, xylachlor, benzyl 4-amino-3-chloro-5-fluoro-6-(4-chloro-2-fluoro-3-methoxyphenyl)pyridine-2-carboxylate and salts, choline salts, esters, optically active isomers and mixtures thereof.

In some embodiments, the compositions described herein are employed in combination with one or more herbicide safeners, such as AD-67 (MON 4660), benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, harpin proteins, isoxadifen-ethyl, jiecaowan, jiecaoxi, mefenpyr-diethyl, mephenate, naphthalic anhydride (NA), oxabetrinil, R29148 and N-phenyl-sulfonylbenzoic acid amides, to enhance their selectivity. In some embodiments, the safeners are employed in rice, cereal, corn, or maize settings. In some embodiments, the safener is cloquintocet or an ester or salt thereof. In certain embodiments, cloquintocet is utilized to antagonize harmful effects of the compositions on rice and cereals. In some embodiments, the safener is cloquintocet (mexyl).

In some embodiments, the compositions and methods described herein can be used in combination with one or more seed treatments known to be employed in the safening of rice and compounds of formula (I), including naphthalic anhydride and CAS registry number 129531-12-0 (N-(2-methoxybenzoyl)-4-[(methylaminocarbonyl)amino]benzenesulfonamide), which has the following structure,

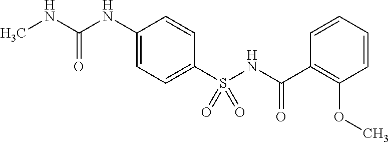

and CAS registry number 98967-94-3 (methyl 3-((5,7-dimethyl[1,2,4]triazolo[1,5-a]pyrimidine)-2-sulfonamido)thiophene-2-carboxylate), which has the following structure,

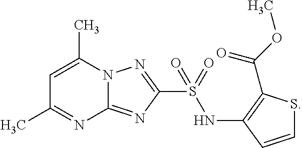 [SMILES: COC(=O)c1sccc1NS(=O)(=O)c1nc2nc(C)cc(C)n2n1]

In some embodiments, the concentration of the active ingredients in the compositions described herein is from about 0.0005 to 98 percent by weight. In some embodiments, the concentration is from about 0.0006 to 90 percent by weight. In compositions designed to be employed as concentrates, the active ingredients, in certain embodiments, are present in a concentration from about 0.1 to 98 weight percent, and in certain embodiments about 0.5 to 90 weight percent. Such compositions are, in certain embodiments, diluted with an inert carrier, such as water, before application. The diluted compositions usually applied to weeds or the locus of weeds contain, in certain embodiments, about 0.005 to 99 weight percent active ingredient and in certain embodiments contain about 0.01 to 25.0 weight percent.

In some embodiments, the compound of formula (I) or agriculturally acceptable ester or salt thereof, florasulam, and pyroxsulam are used in combination with herbicides that are selective for the crops being treated and which complement the spectrum of weeds controlled by these compounds at the application rate employed. In some embodiments, the compositions described herein and other complementary herbicides are applied at the same time, either as a combination formulation or as a tank mix, at the same time or as sequential applications.

The present compositions can be applied to weeds or their locus thereof, including but not limited to, foliage or soil by the use of conventional ground or aerial dusters, sprayers, and granule applicators, and by other conventional means known to those skilled in the art.

Units of weight are expressed in units of weight to weight (g to g), as g ae/ha (grams acid equivalent/ha) to g ai/ha (grams active ingredient/ha); such as g ae/ha to g ai/ha; as g ae/ha to g ae/ha and as g ai/ha to g ai/ha.

In certain embodiments of the compositions and methods described herein, (a) the compound of formula (I) or agriculturally acceptable ester or salt thereof plus (b) florasulam or agriculturally acceptable salt thereof is used in combination with (c) pyroxsulam or agriculturally acceptable salt thereof. With regard to the compositions, in some embodiments, the weight ratio of (a) the compound of formula (I) or agriculturally acceptable ester or salt thereof plus (b) florasulam or agriculturally acceptable salt thereof to (c) pyroxsulam or agriculturally acceptable salt thereof is within the range from about 1:100 to about 100:1, from about 1:90 to about 90:1, from about 1:80 to about 80:1, from about 1:70 to about 70:1, from about 1:60 to about 60:1, from about 1:50 to about 50:1, from about 1:40 to about 40:1, from about 1:30 to about 30:1, from about 1:20 to about 20:1, from about 1:18 to about 18:1, from about 1:15 to about 15:1, from about 1:14 to about 14:1, from about 1:13 to about 13:1, and from about 1:12.5 to about 12.5:1. In additional embodiments, the weight ratio of (a) the compound of formula (I) or agriculturally acceptable ester or salt thereof plus (b) florasulam or agriculturally acceptable salt thereof to (c) pyroxsulam or agriculturally acceptable salt thereof is within the range from about 1:12 to about 12:1, from about 1:11 to about 11:1, from about 1:10 to about 10:1, from about 1:9 to about 9:1, from about 1:8 to about 8:1, from about 1:7 to about 7:1, from about 1:6 to about 6:1, from about 1:5 to about 5:1, from about 1:4 to about 4:1, and from about 1:3.75 to about 3:1. In certain embodiments, the weight ratio of (a) the compound of formula (I) or agriculturally acceptable ester or salt thereof plus (b) florasulam or agriculturally acceptable salt thereof to (c) pyroxsulam or agriculturally acceptable salt thereof is within the range from about 1:3.5 to about 2:1. In other embodiments, the weight ratio of (a) the compound of formula (I) or agriculturally acceptable ester or salt thereof plus (b) florasulam or agriculturally acceptable salt thereof to (c) pyroxsulam or agriculturally acceptable salt thereof is within the range from about 1:3.1 to about 1.5:1.

In certain embodiments of the compositions and methods described herein, the combination of herbicidally active ingredients consists of the three components used in amounts such that the weight ratio of (a) to (b) to (c) is from about 1-80 of (a) to about 1-120 of (b) to about 1-200 of (c). In additional embodiments, the weight ratios of the three components include from about 1-70 of (a) to about 1-100 of (b) to about 1-180 of (c); from about 1-60 of (a) to about 1-90 of (b) to about 1-150 of (c); from about 1-50 of (a) to about 1-80 of (b) to about 1-125 of (c); from about 1-40 of (a) to about 1-70 of (b) to about 1-100 of (c); from about 1-30 of (a) to about 1-50 of (b) to about 1-80 of (c); from about 1-20 of (a) to about 1-40 of (b) to about 1-60 of (c); from about 1-15 of (a) to about 1-30 of (b) to about 1-40 of (c); from about 1-12.5 of (a) to about 1-20 of (b) to about 1-30 of (c); from about 1-11 of (a) to about 1-17.5 of (b) to about 1-27 of (c); and from about 1-10 of (a) to about 1-15 of (b) to about 1-25 of (c). In certain embodiments, (a) the compound of formula (I) or agriculturally acceptable ester or salt thereof, (b) florasulam or agriculturally acceptable salt thereof, and (c) pyroxsulam or agriculturally acceptable salt thereof, are used in amounts such that the weight ratio of (a) to (b) to (c) is from about 1-9 of (a) to about 1-12 of (b) to about 1-20 of (c); from about 1-8 of (a) to about 1-10 of (b) to about 1-18 of (c); from about 1-7 of (a) to about 1-8 of (b) to about 1-15 of (c); from about 1-6 of (a) to about 1-7 of (b) to about 1-12 of (c); from about 1-5 of (a) to about 1-6 of (b) to about 1-10 of (c); from about 1-4 of (a) to about 1-5 of (b) to about 1-8 of (c); and from about 1-3 of (a) to about 1-4 of (b) to about 1-6 of (c). In other embodiments, (a) the compound of formula (I) or agriculturally acceptable ester or salt thereof, (b) florasulam or agriculturally acceptable salt thereof, and (c) pyroxsulam or agriculturally acceptable salt thereof, are used in amounts such that the weight ration of (a) to (b) to (c) is from about 1-2 to about 1-2.1 to about 1-4.

In the embodiments just described, the weight ratio of (a) the compound of formula (I) or agriculturally acceptable ester or salt thereof to (b) florasulam or agriculturally acceptable salt thereof [i.e. (a):(b)] can be further defined such that the weight ratio of (a) to (b) is from about 1:120 to about 80:1. In additional embodiments, the weight ratio of the two components include from about 1:100 to about 75:1; from about 1:90 to about 1:70; from about 1:80 to about 75:1; from about 1:70 to about 70:1; from about 1:60 to about 60:1; from about 1:50 to about 50:1; from about 1:35 to about 35:1; from about 1:25 to about 25:1; from about 1:20 to about 20:1; from about 1:17 to about 17:1; from about 1:16 to about 15:1; and from about 1:15 to about 10:1. In additional embodiments, the weight ratio of the two components include from about 1:12 to about 8:1; from about 1:10 to about 7.5:1; from about 1:8 to about 7:1; from about 1:6 to about 6:1; from about 1:5 to about 5:1; from about 1:4 to about 4:1; from about 1:3 to about 3:1; from about 1:2.5 to about 2.5:1; and from about 1:2.1 to about 2:1.

With respect to the methods, in certain embodiments, the methods comprise contacting the undesirable vegetation with a composition described herein, e.g., sequentially or simultaneously. In some embodiments, the composition is applied at an application rate from about 1.00 grams active ingredient per hectare (g ai/ha) to about 100 g ai/ha based on the total amount of active ingredients in the composition. In certain embodiments, the composition is applied at an application rate from about 4 g ai/ha to about 50 g ai/ha based on the total amount of active ingredients in the composition. In certain embodiments, the composition is applied at an application rate from about 10 g ai/ha to about 40 g ai/ha based on the total amount of active ingredients in the composition. In certain embodiments, the composition is applied at an application rate from about 15.6 g ai/ha to about 31 g ai/ha based on the total amount of active ingredients in the composition.

The components of the mixtures described herein can be applied either separately, sequentially, tank-mixed or as part of a multipart herbicidal system. In some embodiments, all three components may be formulated together (e.g., in the same formulation) or separately (e.g., in separate formulations) and applied simultaneously. Alternatively, two of the three components can be formulated together (e.g., the compound of formula (I) or agriculturally acceptable ester or salt thereof and florasulam or agriculturally acceptable salt thereof) and the third component (pyroxsulam or agriculturally acceptable salt thereof) formulated separately and the two formulations applied simultaneously. In another embodiment, one or more components may be formulated separately and the components applied sequentially or in a tank mix. For example, each component can be formulated separately and the three components applied sequentially or in a tank mix. Alternatively, two of the three components can be formulated together (e.g., the compound of formula (I) or agriculturally acceptable ester or salt thereof and florasulam or agriculturally acceptable salt thereof) and the third component (pyroxsulam or agriculturally acceptable salt thereof) formulated separately and the two formulations applied sequentially or in a tank mix. Alternatively, two of the three components can be formulated together (e.g., the compound of formula (I) or agriculturally acceptable ester or salt thereof and pyroxsulam or agriculturally acceptable salt thereof) and the third component (florasulam or agriculturally acceptable salt thereof) formulated separately and the two formulations applied sequentially or in a tank mix. The time period between applications can vary, for example 0.0001, 0.001, 0.01, 0.1, 0.25, 0.5, 1, 2, 4, 6, 8, 10, or 12 hours or longer or 1, 2, 3, 4, 5, 6, or 7 days or longer.

In one embodiment, the compositions exhibit synergy against a variety of weed types. In one embodiment, the combination of the compound of formula (I) or agriculturally acceptable ester or salt thereof plus florasulam or agriculturally acceptable salt thereof to pyroxsulam or agriculturally acceptable salt thereof in a ratio of about 1:2.9 to about 1.2:1 exhibits greater than about 3, 4, 5, 6, 7, 8, 9, 10, 11, 12, 13, 15, 18, 20, 22, 25, 28, 29, 30, 35, 37, 39, or 40% control compared to the Colby predicted value at 14-78 days after application (DAA).

In one embodiment, the compositions exhibit synergy against a variety of weed types. In one embodiment, the combination of the compound of formula (I) or agriculturally acceptable ester or salt thereof to florasulam or agriculturally acceptable salt thereof to pyroxsulam or agriculturally acceptable salt thereof in a ratio of about 1:2.1:6.25 to about 1:0.63:2 exhibits greater than about 4, 5, 6, 7, 8, 9, 10, 11, 12, 15, 16, 17, 18, 20, 22, 23, 25, 28, 30, 33, 35, 37, 39, 40, 45, 48, 50, 52, or 55% control compared to the Colby predicted value at 14-84 days after application (DAA).

In another embodiment, the compositions exhibit synergy as defined by the efficacy values defined above against a variety of weed types or crops, including but not limited to, Agropyron repens L. (quackgrass, AGRRE), Alopecurus myosuroides Huds. (blackgrass, ALOMY), Apera spica-venti (L.) Beauv. (windgrass, APESV), Centaurea cyanus (cornflower, CENCY), Consolida regalis S. F. Gray (branching larkspur, CNSRE), Echinochloa crus-galli (L.) P. Beauv. (barnyardgrass, ECHCG), Galium aparine L. (catchweed bedstraw, GALAP), Lamium purpureum L. (purple deadnettle, LAMPU), Matricaria recutita L. (wild chamomile, MATCH), Matricaria inodora (scentless mayweed, MATIN), Solanum nigrum L. (black nightshade, SOLNI), Stellaria media (L.) Vill. (common chickweed, STEME), and Viola arvensis Murr. (field violet, VIOAR).

In another embodiment, the compositions exhibit synergy as defined by the efficacy values defined above against a variety of weed types or crops, including but not limited to, Avena sp. (oats, AVESS), Avena macrocarpa Moench (wild red oat, AVEST), Lamium purpureum L. (purple deadnettle, LAMPU), Lolium multiflorum Lam. (Italian ryegrass, LOLMU), Lolium rigidum (rigid ryegrass, LOLRI), Lolium L. sp. (ryegrass, LOLSS), Papaver rhoeas L. (common poppy, PAPRH), Solanum nigrum L. (black nightshade, SOLNI), and Stellaria media (L.) Vill. (common chickweed, STEME).

In another embodiment, the compositions can be used to control glyphosate-tolerant soybeans (GLXMA), cotton (GOSHI), sunflower (HELAN) and other crops that have single site tolerance to, including but not limited to, glyphosate, ALS, ACCase, glufosinate, and other herbicide modes of action.

### IV. Methods of Use

Herbicidal activity (control of undesirable vegetation in a crop or non-crop situation) is exhibited by the herbicidal compositions when they are applied pre- and post-emergence directly to the plant or to the locus of the plant at any stage of growth, or to the area where control of vegetation is desired. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted to promote non-selective or selective herbicidal action. In some embodiments, the compositions described herein are applied as a post-emergence application to the crop and undesirable vegetation, pre-emergence application to the crop and post-emergence to the undesirable vegetation, and as multiple post-emergence applications to relatively immature and mature undesirable vegetation to achieve the maximum control of weeds.

In some embodiments, methods of controlling undesirable vegetation in non-crop, perennial crop, fruiting crop, or plantation crop areas, comprising contacting undesirable vegetation or the locus thereof, including but not limited to foliage, soil or water, with a composition containing a mixture containing herbicidally effective amounts of (a) the compound of formula (I) or agriculturally acceptable ester or salt thereof, (b) florasulam or agriculturally acceptable salt thereof, and (c) pyroxsulam or agriculturally acceptable salt thereof are described herein. In certain embodiments, the methods employ the compositions described herein.

The compositions and methods provided herein are utilized to control undesirable vegetation. Undesirable vegetation includes, but is not limited to, undesirable vegetation that occurs in oilseed rape/canola, vegetables, Brassica spp, ornamentals, cereal crops, including but not limited to rice, wheat, teff, triticale, barley, oats, rye, sorghum, and corn/maize; row crops, fallow-bed, sunflower, sugarcane, non-crop areas, including but not limited to pastures, grasslands, rangelands, fallowland, fencerows, parking areas, tank farms, storage areas, rights-of-way, utility areas, turf, forestry, aquatics, industrial vegetation management (IVM) and fallow-bed prior to planting crops; perennial crops where the application contacts the undesirable vegetation but does not contact the crop foliage, such as tree and vine orchards, including but not limited to citrus, grapes, almond, apple, apricot, avocado, banana, beechnut, Brazil nut, butternut, cashew, cherry, chestnut, chinquapin, crab apple, date, feijoa, fig, filbert, hickory nut, kiwi, lemon, lime, loquat, macadamia nut, mandarin, mango, mayhaw, nectarine, olive, oranges, peach, pear, pecan, persimmon, pistachio, plum, pome fruit, pomegranate, prune, quince, stone fruit, tree nuts and walnut; fruiting crops (e.g., blueberries, guava, papaya, pineapple, strawberries, taro, blackberries and raspberries); and plantation crops (including, but not limited to, coffee, cacao, rubber and palm oil).

The compositions and methods provided herein are utilized to control undesirable vegetation. Undesirable vegetation includes, but is not limited to, undesirable vegetation that occurs in annual crops such as 2,4-D-, ALS-, ACCase-, glyphosate- and glufosinate-tolerant cereal crops, including but not limited to rice, wheat, barley, oats, teff, rye and sorghum.

In some embodiments, the methods provided herein are utilized to control undesirable vegetation in oilseed rape, canola, drilled crops and cereal crops. In certain embodiments, the undesirable vegetation is Agropyron repens L. (quackgrass, AGRRE), Alopecurus myosuroides Huds. (blackgrass, ALOMY), Apera spica-venti (L.) Beauv. (windgrass, APESV), Avena fatua L. (wild oat, AVEFA), Avena sp. (oats, AVESS), Avena macrocarpa Moench (wild red oat, AVEST), Bromus tectorum L. (downy brome, BROTE), Centaurea cyanus (cornflower, CENCY), Consolida regalis S. F. Gray (branching larkspur, CNSRE), Lolium multiflorum Lam. (Italian ryegrass, LOLMU), Lolium rigidum (rigid ryegrass, LOLRI), Lolium multiflorum subsp. Gaudini (annual ryegrass, LOLMG), Matricaria inodora (scentless mayweed, MATIN), Phalaris minor Retz. (littleseed canarygrass, PHAMI), Poa annua L. (annual bluegrass, POAAN), Setaria pumila (Poir.) Roemer & J. A. Schultes (yellow foxtail, SETLU), Setaria viridis (L.) Beauv. (green foxtail, SETVI), Cirsium arvense (L.) Scop. (Canada thistle, CIRAR), Galium aparine L. (catchweed bedstraw, GALAP), Kochia scoparia (L.) Schrad. (kochia, KCHSC), Lamium purpureum L. (purple deadnettle, LAMPU), Lolium L. sp. (ryegrass, LOLSS), Matricaria recutita L. (wild chamomile, MATCH), Matricaria matricarioides (Less.) Porter (pineappleweed, MATMT), Papaver rhoeas L. (common poppy, PAPRH), Polygonum convolvulus L. (wild buckwheat, POLCO), Salsola tragus L. (Russian thistle, SASKR), Solanum nigrum L. (black nightshade, SOLNI), Stellaria media (L.) Vill. (common chickweed, STEME), Veronica persica Poir. (Persian speedwell, VERPE), Viola arvensis Murr. (field violet, VIOAR), or Viola tricolor L. (wild violet, VIOTR).

In some embodiments, the compositions and methods provided herein are utilized to control undesirable vegetation in rice. In certain embodiments, the undesirable vegetation is Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Ischaemum rugosum Salisb. (saramollagrass, ISCRU), Leptochloa chinensis (L.) Nees (Chinese sprangletop, LEFCH), Leptochloa fascicularis (Lam.) Gray (bearded sprangletop, LEFFA), Leptochloa panicoides (Presl.) Hitchc. (Amazon sprangletop, LEFPA), Panicum dichotomiflorum (L.) Michx. (Fall panicum, PANDI), Paspalum dilatatum Poir. (dallisgrass, PASDI), Cyperus difformis L. (smallflower flatsedge, CYPDI), Cyperus esculentus L. (yellow nutsedge, CYPES), Cyperus iria L. (rice flatsedge, CYPIR), Cyperus rotundus L. (purple nutsedge, CYPRO), Eleocharis species (ELOSS), Fimbristylis miliacea (L.) Vahl (globe fringerush, FIMMI), Schoenoplectus juncoides Roxb. (Japanese bulrush, SCPJU), Schoenoplectus maritimus L. (sea clubrush, SCPMA), Schoenoplectus mucronatus L. (ricefield bulrush, SCPMU), Aeschynomene species, (jointvetch, AESSS), Alternanthera philoxeroides (Mart.) Griseb. (alligatorweed, ALRPH), Alisma plantago-aquatica L. (common water plantain, ALSPA), Amaranthus species, (pigweeds and amaranths, AMASS), Ammannia coccinea Rottb. (redstem, AMMCO), Eclipta alba (L.) Hassk. (American false daisy, ECLAL), Heteranthera limosa (SW.) Willd./Vahl (ducksalad, HETLI), Heteranthera reniformis R. & P. (roundleaf mudplantain, HETRE), Ipomoea hederacea (L.) Jacq. (ivyleaf morningglory, IPOHE), Lindernia dubia (L.) Pennell (low false pimpernel, LIDDU), Monochoria korsakowii Regel & Maack (monochoria, MOOKA), Monochoria vaginalis (Burm. F.) C. Presl ex Kuhth, (monochoria, MOOVA), Murdannia nudiflora (L.) Brenan (doveweed, MUDNU), Polygonum pensylvanicum L., (Pennsylvania smartweed, POLPY), Polygonum persicaria L. (ladysthumb, POLPE), Polygonum hydropiperoides Michx. (mild smartweed, POLHP), Rotala indica (Willd.) Koehne (Indian toothcup, ROTIN), Sagittaria species, (arrowhead, SAGSS), Sesbania exaltata (Raf.) Cory/Rydb. Ex Hill (hemp sesbania, SEBEX), Solanum nigrum L. (black nightshade, SOLNI), or Sphenoclea zeylanica Gaertn. (gooseweed, SPDZE).

In some embodiments, the methods provided herein are utilized to control undesirable vegetation found in tree and vine crops, perennial crops, IVM and non-crop areas. In certain embodiments, the undesirable vegetation is Alopecurus myosuroides Huds. (blackgrass, ALOMY), Amaranthus palmeri S. Wats. (Palmer amaranth, AMAPA), Avena fatua L. (wild oat, AVEFA), Brachiaria decumbens Stapf. or Urochloa decumbens (Stapf) R. D. Webster (Surinam grass, BRADC), Brachiaria brizantha (Hochst. ex A. Rich.) Stapf. or Urochloa brizantha (Hochst. ex A. Rich.) R. D. (beard grass, BRABR), Brachiaria platyphylla (Groseb.) Nash or Urochloa platyphylla (Nash) R. D. Webster (broadleaf signalgrass, BRAPP), Brachiaria plantaginea (Link) Hitchc. or Urochloa plantaginea (Link) R. D. Webster (alexandergrass, BRAPL), Cenchrus echinatus L. (southern sandbur, CENEC), Digitaria horizontalis Willd. (Jamaican crabgrass, DIGHO), Digitaria insularis (L.) Mez ex Ekman (sourgrass, TRCIN), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Eleusine indica (L.) Gaertn. (goosegrass, ELEIN), Lolium multiflorum Lam. (Italian ryegrass, LOLMU), Panicum dichotomiflorum Michx. (fall panicum, PANDI), Panicum miliaceum L. (wild-proso millet, PANMI), Sesbania exaltata (Raf.) Cory/Rydb. Ex Hill (hemp sesbania, SEBEX), Setaria faberi Herrm. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida L. (giant ragweed, AMBTR), Anoda cristata (L.) Schlecht. (spurred anoda, ANVCR), Asclepias syriaca L. (common milkweed, ASCSY), Bidens pilosa L. (hairy beggarticks, BIDPI), Borreria species (BOISS), Borreria alata (Aubl.) DC., Spermacoce alata Aubl. or Spermacoce latifolia (broadleaf buttonweed, BOILF), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carota L. (wild carrot, DAUCA), Euphorbia heterophylla L. (wild poinsettia, EPHHL), Euphorbia hirta L. or Chamaesyce hirta (L.) Millsp. (garden spurge, EPHHI), Euphorbia dentata Michx. (toothed spurge, EPHDE), Erigeron bonariensis L. or Conyza bonariensis (L.) Cronq. (hairy fleabane, ERIBO), Erigeron canadensis L. or Conyza canadensis (L.) Cronq. (horseweed, ERICA), Conyza sumatrensis (Retz.) E. H. Walker (tall fleabane, ERIFL), Helianthus annuus L. (common sunflower, HELAN), Jacquemontia tamnifolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Richardia species (pusley, RCHSS), Salsola tragus L. (Russian thistle, SASKR), Sida species (sida, SIDSS), Sida spinosa L. (prickly sida, SIDSP), Sinapis arvensis L. (wild mustard, SINAR), Solanum ptychanthum Dunal (eastern black nightshade, SOLPT), Tridax procumbens L. (coat buttons, TRQPR), or Xanthium strumarium L. (common cocklebur, XANST).

In some embodiments, the methods provided herein are utilized to control undesirable vegetation in range and pasture. In certain embodiments, the undesirable vegetation is Amaranthus palmeri S. Wats. (Palmer amaranth, AMAPA), Ambrosia artemisiifolia L. (common ragweed, AMBEL), Ambrosia trifida L. (giant ragweed, AMBTR), Cassia obtusifolia (sickle pod, CASOB), Centaurea maculosa auct. non Lam. (spotted knapweed, CENMA), Cirsium arvense (L.) Scop. (Canada thistle, CIRAR), Convolvulus arvensis L. (field bindweed, CONAR), Echinochloa crus-galli (L.) P. Beauv. (barnyardgrass, ECHCG), Erigeron canadensis L. or Conyza canadensis (L.) Cronq. (horseweed, ERICA), Euphorbia esula L. (leafy spurge, EPHES), Lactuca serriola L./Torn. (prickly lettuce, LACSE), Plantago lanceolata L. (buckhorn plantain, PLALA), Rumex obtusifolius L. (broadleaf dock, RUMOB), Salsola tragus L. (Russian thistle, SASKR), Sesbania exaltata (Raf.) Cory/Rydb. Ex Hill (hemp sesbania, SEBEX), Sida spinosa L. (prickly sida, SIDSP), Sinapis arvensis L. (wild mustard, SINAR), Sonchus arvensis L. (perennial sowthistle, SONAR), Solanum nigrum L. (black nightshade, SOLNI), Solanum species (nightshade, SOLSS), Solidago species (goldenrod, SOOSS), Taraxacum officinale G. H. Weber ex Wiggers (dandelion, TAROF), Trifolium repens L. (white clover, TRFRE), or Urtica dioica L. (common nettle, URTDI).

In some embodiments, the compostions and methods provided herein are utilized to control undesirable vegetation found in annual crops and vegetable crops. In certain embodiments, the undesirable vegetation is Alopecurus myosuroides Huds. (blackgrass, ALOMY), Avena fatua L. (wild oat, AVEFA), Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Lolium multiflorum Lam. (Italian ryegrass, LOLMU), Panicum dichotomiflorum Michx. (Fall panicum, PANDI), Panicum miliaceum L. (wild-proso millet, PANMI), Setaria faberi Herrm. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (Western ragweed, AMBPS), Ambrosia trifida L. (giant ragweed, AMBTR), Asclepias syriaca L. (common milkweed, ASCSY), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carota L. (wild carrot, DAUCA), Euphorbia heterophylla L. (wild poinsettia, EPHHL), Erigeron bonariensis L. or Conyza bonariensis (L.) Cronq. (hairy fleabane, ERIBO), Erigeron canadensis L. or Conyza canadensis (L.) Cronq. (Canadian fleabane, ERICA), Helianthus annuus L. (common sunflower, HELAN), Jacquemontia tamnifolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Sida spinosa L. (prickly sida, SIDSP), Sinapis arvensis L. (wild mustard, SINAR), Solanum ptychanthum Dunal (eastern black nightshade, SOLPT), or Xanthium strumarium L. (common cocklebur, XANST).

In some embodiments, the compositions and methods provided herein are utilized to control undesirable vegetation consisting of grass, broadleaf and sedge weeds.

In some embodiments, the compositions and methods are used to control Agropyron repens L. (quackgrass, AGRRE), Alopecurus myosuroides Huds. (blackgrass, ALOMY), Apera spica-venti (L.) Beauv. (windgrass, APESV), Avena sp. (oats, AVESS), Avena macrocarpa Moench (wild red oat, AVEST), Centaurea cyanus (cornflower, CENCY), Consolida regalis S. F. Gray (branching larkspur, CNSRE), Echinochloa crus-galli (L.) P. Beauv. (barnyardgrass, ECHCG), Galium aparine L. (catchweed bedstraw, GALAP), Lamium purpureum L. (purple deadnettle, LAMPU), Lolium multiflorum Lam. (Italian ryegrass, LOLMU), Lolium rigidum (rigid ryegrass, LOLRI), Lolium L. sp. (ryegrass, LOLSS), Matricaria recutita L. (wild chamomile, MATCH), Matricaria inodora (scentless mayweed, MATIN), Papaver rhoeas L. (common poppy, PAPRH), Solanum nigrum L. (black nightshade, SOLNI), and Stellaria media (L.) Vill. (common chickweed, STEME), and Viola arvensis Murr. (field violet, VIOAR).

In some embodiments, the methods provided herein may be used to control herbicide resistant or tolerant weeds. The methods employing the combination of a compound of formula (I) or agriculturally acceptable ester or salt thereof, florasulam or agriculturally acceptable salt thereof, and pyroxsulam or agriculturally acceptable salt thereof, and the compositions described herein may also be employed to control herbicide resistant or tolerant weeds. Exemplary resistant or tolerant weeds include, but are not limited to, biotypes resistant or tolerant to acetolactate synthase (ALS) or acetohydroxy acid synthase (AHAS) inhibitors (e.g., imidazolinones, sulfonylureas, pyrimidinylthiobenzoates, dimethoxy-pyrimidines, triazolopyrimidine sulfonamides, sulfonylaminocarbonyltriazolinones), photosystem II inhibitors (e.g., phenylcarbamates, pyridazinones, triazines, triazinones, uracils, amides, ureas, benzothiadiazinones, nitriles, phenylpyridazines), acetyl CoA carboxylase (ACCase) inhibitors (e.g., aryloxyphenoxy-propionates, cyclohexanediones, phenylpyrazolines), synthetic auxins (e.g., benzoic acids, phenoxycarboxylic acids, pyridine carboxylic acids, quinoline carboxylic acids), auxin transport inhibitors (e.g., phthalamates, semicarbazones), photosystem I inhibitors (e.g., bipyridyliums), 5-enolpyruvylshikimate-3-phosphate (EPSP) synthase inhibitors (e.g., glyphosate), glutamine synthetase inhibitors (e.g., glufosinate, bialafos), microtubule assembly inhibitors (e.g., benzamides, benzoic acids, dinitroanilines, phosphoramidates, pyridines), mitosis inhibitors (e.g., carbamates), very long chain fatty acid (VLCFA) inhibitors (e.g., acetamides, chloroacetamides, oxyacetamides, tetrazolinones), fatty acid and lipid synthesis inhibitors (e.g., phosphorodithioates, thiocarbamates, benzofuranes, chlorocarbonic acids), protoporphyrinogen oxidase (PPO) inhibitors (e.g., diphenylethers, N-phenylphthalimides, oxadiazoles, oxazolidinediones, phenylpyrazoles, pyrimidinediones, thiadiazoles, triazolinones), carotenoid biosynthesis inhibitors (e.g., clomazone, amitrole, aclonifen), phytoene desaturase (PDS) inhibitors (e.g., amides, anilidex, furanones, phenoxybutan-amides, pyridiazinones, pyridines), 4-hydroxyphenyl-pyruvate-dioxygenase (HPPD) inhibitors (e.g., callistemones, isoxazoles, pyrazoles, triketones), cellulose biosynthesis inhibitors (e.g., nitriles, benzamides, quinclorac, triazolocarboxamides), herbicides with multiple modes of action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to single or multiple herbicides, biotypes with resistance or tolerance to single or multiple chemical classes, biotypes with resistance or tolerance to single or multiple herbicide modes of action, and biotypes with single or multiple resistance or tolerance mechanisms (e.g., target site resistance or metabolic resistance).

The compositions and methods described herein are used to control undesirable vegetation in glyphosate-, 2,4-D- and glufosinate-tolerant cereals, corn, or sorghum which may also be combined with traits providing dicamba-tolerance (e.g., DMO), pyridyloxy auxin-tolerance (e.g., aad-12, aad-13), auxin-tolerance, auxin transport inhibitor-tolerance, acetyl CoA carboxylase (ACCase) inhibitor-herbicide tolerance [e.g., aryloxyphenoxypropionate, cyclohexanedione, and phenylpyrazoline chemistries (e.g., various ACCase genes and aad-1 gene)], acetolactate synthase (ALS)-inhibiting herbicide tolerance (e.g., imidazolinone, sulfonylurea, triazolopyrimidine sulfonamide, pyrmidinylthiobenzoate, and other chemistries=AHAS, Csrl, SurA), 4-hydroxyphenyl-pyruvate dioxygenase (HPPD) inhibitor-tolerance, phytoene desaturase (PDS) inhibitor-tolerance (e.g., pds, CYP1A1, CYP2B6, CYP2C19), carotenoid biosynthesis inhibitor-tolerance, protoporphyrinogen oxidase (PPO) inhibitor-tolerance, cellulose biosynthesis inhibitor-tolerance (e.g., ixr2-1, CYP1A1), mitosis inhibitor-tolerance, microtubule inhibitor-tolerance, very long chain fatty acid (VLCFA) inhibitor-tolerance (e.g., CYP1A1, CYP2B6, CYP2C19), fatty acid and lipid biosynthesis inhibitor-tolerance (e.g., CYP1A1), photosystem I inhibitor-tolerance (e.g., SOD), photosystem II inhibitor (triazine, nitrile, and phenylurea chemistries) tolerance (e.g., psbA, CYP1A1, CYP2B6, CYP2C19, and Bxn), in crops (such as, but not limited to, corn, canola/oilseed rape, rice, cereals, sorghum, sunflower, sugar beet, sugarcane, and turf), for example, in conjunction with glyphosate, 5-enolpyruvylshikimate-3-phosphate (EPSP) synthase inhibitors, glutamine synthase inhibitors, dicamba, phenoxy auxins, pyridyloxy auxins, synthetic auxins, auxin transport inhibitors, aryloxyphenoxypropionates, cyclohexanediones, phenylpyrazolines, ACCase inhibitors, imidazolinones, sulfonylureas, pyrimidinylthiobenzoates, dimethoxy-pyrimidines, triazolopyrimidine sulfonamides, sulfonylaminocarbonyltriazolinones, ALS or acetohydroxy acid synthase (AHAS) inhibitors, HPPD inhibitors, PDS inhibitors, carotenoid biosynthesis inhibitors, PPO inhibitors, cellulose biosynthesis inhibitors, mitosis inhibitors, microtubule inhibitors, very long chain fatty acid inhibitors, fatty acid and lipid biosynthesis inhibitors, photosystem I inhibitors, photosystem II inhibitors, triazines, and bromoxynil. The compositions and methods may be used in controlling undesirable vegetation in cereals, soybeans, corn, or cotton possessing single and multiple or stacked traits conferring tolerance to single or multiple chemistries and/or inhibitors of multiple modes of action.

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### EXAMPLES

### Example 1. Evaluation of Herbicidal Activity of Mixtures Under Field Conditions

Methodology

Eleven small plot field trials were established across various ecozones in Belgium, Germany, Hungary, Morocco, Poland, Spain, Tunisia and Turkey, between 2010 and 2014 to evaluate potential synergy between 1) florasulam (250 WG and 50 grams active ingredient per liter (g ai/L)) plus 2) halauxifen-methyl (200 WG, 100 WG, 95.9 grams acid equivalent per liter (g ae/L) SC and 7.5 g ae/L EC) plus 3) pyroxsulam (75 WG) when applied in three-way combinations. Two-way combinations were applied as florasulam+halauxifen-methyl (200 WG and 8.75 gr ae/L OD) in combination with pyroxsulam (75 WG as “PERUN” and 450D as “PALLUS”). Except for the trials utilizing the OD formulations, Actirob B was applied at 0.5 or 1.0 liters per hectare (L/ha), or Polyglycol 26-2 was applied at 0.5 to 1.0 L/ha in all respective single and tankmixture treatments being evaluated.

Trials were established as randomized complete blocks (RCBD) with three to four replicates. Individual treatments were 2-2.5 meters (m) wide and 6-20 m long. An untreated control was included in each trial. All trial sites had naturally occurring populations of weeds. Wheat trials (Triticum aestivum) were generally planted, depending on the country and normal time of planting, from September to November, and herbicide treatments were applied during the normal spring timing from January to April.

Herbicides were applied with backpack or bicycle sprayers using compressed air, nitrogen (N₂) or carbon dioxide (CO₂) as a propellant. All sprayers delivered a uniform spray pattern that provided thorough coverage of the foliage using a water volume of 150-300 L/ha. All herbicides were applied post-emergence in the spring to early-summer At the time of herbicide applications, winter wheat crops were at the six-leaf to three-tiller stage. Broadleaf and grass weeds were at a similar stage of growth at the time of herbicide application, typically from five leaf to 3 tiller depending on the weed species and time of year.

Evaluation

The treated plots and control plots were rated blind at various intervals after application. Ratings were based on a Percent (%) Visual basis, where 0 corresponds to no visual effect as seen as exemplified by weed control or crop injury and 100 corresponds to complete kill of the target weeds or complete crop injury. The control of the target weeds was visually assessed as percent control, compared to an untreated control plot. The assessments were based on a percent visual reduction in pest plant biomass and/or stand reduction of weed population. In general, three-to-four replicates were assessed for each treatment, and the results for each experiment (trial) are presented as overall average control.

The efficacy of all treatments was assessed at 13-22 days after application (DAA) for an early season rating, 23-39 DAA for a mid-season rating, and 41-84 DAA for a late-season rating. The data were statistically analyzed using various statistical methods, generally including a Tukey's HSD Factorial Analysis of Variance with a significance level of 5%.

Data were collected for all trials and analyzed using various statistical methods.

Colby's equation was used to determine the herbicidal effects expected from the mixtures (Colby, S. R. Calculation of the synergistic and antagonistic response of herbicide combinations. Weeds 1967, 15, 20-22). A t-test (alpha=0.05) between Colby predictions and observed combinations was used to test for significant differences indicating synergy or antagonism using replicate data. The results presented in the Tables were significant according to the described criteria.

The following equation was used to calculate the expected activity of mixtures containing three active ingredients, A. B, and C:

Expected=A+B+C−(AB+AC+BC)/100+(ABC)/10,000

A=observed efficacy of active ingredient A at the same concentration as used in the mixture;

B=observed efficacy of active ingredient B at the same concentration as used in the mixture;

C=observed efficacy of active ingredient C at the same concentration as used in the mixture.

Some experiments described herein were performed such that active ingredients A and B were combined and only the efficacy of the combination was determined. As such, Colby's equation simplifies to

Expected=Z+C−(ZC/100)

Z=observed efficacy of a combination of active ingredient A (the compound of formula (I) or agriculturally acceptable ester or salt thereof) and active ingredient B (florasulam or agriculturally acceptable salt thereof) at the same concentration as used in the mixture;

C=observed efficacy of active ingredient C (pyroxsulam or agriculturally acceptable salt thereof) at the same concentration as used in the mixture.

The results are summarized in Tables 1-4.

TABLE 1
Herbicidal Broadleaf Weed Control (% Visual Control) from Three-Way
Tank Mixtures of Halauxifen-Methyl + Florasulam + Pyroxsulam in
Multiple Field Trials at 14 to 56 Days After Application (DAA).

| | | | | | | | | Combination | |
|---|---|---|---|---|---|---|---|---|---|
| | | Halauxifen- | | | | | | | Colby |
| | | Methyl | | Florasulam | | Pyroxsulam | | Observed | Predicted |
| Weed | | | Mean % | | Mean % | | Mean % | Mean % | Mean % |
| Bayer | Evaluation | | Weed | | Weed | | Weed | Weed | Weed |
| Code | Interval | g ae/ha | Control | g ai/ha | Control | g ai/ha | Control | Control | Control |
| MATIN | 14DAA | 3 | 0.0 | 4 | 35.0 | 12 | 20.0 | 50.0 | 48.0 |
| MATIN | 14DAA | 4 | 0.0 | 3 | 30.0 | 12 | 20.0 | 65.0 | 44.0 |
| VIOAR | 14DAA | 3 | 0.0 | 3 | 0.0 | 12 | 61.3 | 83.8 | 61.3 |
| VIOAR | 14DAA | 4 | 0.0 | 3 | 0.0 | 12 | 61.3 | 78.8 | 61.3 |
| LAMPU | 15DAA | 4.8 | 72.5 | 3.75 | 0.0 | 12 | 10.0 | 95.0 | 75.3 |
| LAMPU | 15DAA | 6 | 55.0 | 3.75 | 0.0 | 12 | 10.0 | 95.0 | 59.6 |
| LAMPU | 15DAA | 4.8 | 72.5 | 3.75 | 0.0 | 9.6 | 16.3 | 95.0 | 76.9 |
| LAMPU | 15DAA | 6 | 55.0 | 3.75 | 0.0 | 9.6 | 16.3 | 95.0 | 62.3 |
| MATCH | 15DAA | 4.8 | 0.0 | 3.75 | 10.0 | 9.6 | 12.8 | 32.5 | 21.5 |
| STEME | 15DAA | 4.8 | 0.0 | 3.75 | 0.0 | 12 | 0.0 | 23.8 | 0.0 |
| STEME | 15DAA | 6 | 0.0 | 3.75 | 0.0 | 12 | 0.0 | 26.3 | 0.0 |
| STEME | 15DAA | 4.8 | 0.0 | 3.75 | 0.0 | 9.6 | 0.0 | 32.5 | 0.0 |
| STEME | 15DAA | 6 | 0.0 | 3.75 | 0.0 | 9.6 | 0.0 | 23.8 | 0.0 |
| CENCY | 28DAA | 3 | 75.0 | 3 | 48.8 | 12 | 38.8 | 99.5 | 92.2 |
| CENCY | 28DAA | 3 | 75.0 | 4 | 75.0 | 12 | 38.8 | 99.8 | 96.1 |
| GALAP | 28DAA | 3 | 0.0 | 3 | 57.5 | 12 | 89.5 | 99.5 | 95.6 |
| SOLNI | 29DAA | 3 | 10.0 | 6.25 | 40.0 | 18.75 | 50.0 | 90.0 | 73.0 |
| CNSRE | 31DAA | 3 | 68.3 | 4 | 75.0 | 12 | 66.8 | 99.5 | 97.4 |
| CNSRE | 31DAA | 4 | 70.8 | 3 | 75.0 | 12 | 66.8 | 100.0 | 97.6 |
| CNSRE | 31DAA | 4 | 70.8 | 4 | 75.0 | 12 | 66.8 | 100.0 | 97.6 |
| CNSRE | 53DAA | 3 | 70.0 | 3 | 78.5 | 12 | 70.0 | 100.0 | 98.1 |
| CNSRE | 53DAA | 3 | 70.0 | 4 | 79.5 | 12 | 70.0 | 100.0 | 98.2 |
| CNSRE | 53DAA | 4 | 72.0 | 3 | 78.5 | 12 | 70.0 | 100.0 | 98.2 |
| CNSRE | 53DAA | 4 | 72.0 | 4 | 79.5 | 12 | 70.0 | 100.0 | 98.3 |
| CENCY | 56DAA | 3 | 2.5 | 3 | 27.5 | 12 | 15.0 | 57.5 | 39.8 |
| CENCY | 56DAA | 3 | 2.5 | 4 | 30.0 | 12 | 15.0 | 62.5 | 42.4 |
| CENCY | 56DAA | 3 | 83.8 | 3 | 48.8 | 12 | 32.5 | 99.5 | 94.1 |
| CENCY | 56DAA | 3 | 83.8 | 4 | 83.8 | 12 | 32.5 | 99.8 | 98.1 |
| SOLNI | 56DAA | 3 | 0.0 | 6.25 | 20.0 | 18.75 | 30.0 | 90.0 | 44.0 |
| VIOAR | 56DAA | 3 | 0.0 | 4 | 20.0 | 12 | 93.8 | 99.5 | 95.1 |

TABLE 2
Herbicidal Broadleaf Weed Control (% Visual Control) from Three-Way Tank Mixtures
of Halauxifen-Methyl + Florasulam + Pyroxsulam in Multiple Field Trials
at 61 to 84 Days After Application (DAA).

| | | | | | | | | Combination | |
|---|---|---|---|---|---|---|---|---|---|
| | | Halauxifen- | | | | | | | Colby |
| | | Methyl | | Florasulam | | Pyroxsulam | | Observed | Predicted |
| Weed | | | Mean % | | Mean % | | Mean % | Mean % | Mean % |
| Bayer | Evaluation | | Weed | | Weed | | Weed | Weed | Weed |
| Code | Interval | g ae/ha | Control | g ai/ha | Control | g ai/ha | Control | Control | Control |
| MATCH | 61DAA | 4.8 | 0.0 | 3.75 | 85.0 | 12 | 20.0 | 98.0 | 88.1 |
| MATCH | 61DAA | 6 | 1.3 | 3.75 | 85.0 | 12 | 20.0 | 98.3 | 88.2 |
| MATCH | 61DAA | 4.8 | 0.0 | 3.75 | 85.0 | 9.6 | 16.3 | 98.3 | 87.5 |
| MATCH | 61DAA | 6 | 1.3 | 3.75 | 85.0 | 9.6 | 16.3 | 98.0 | 87.6 |
| MATCH | 61DAA | 4.8 | 0.0 | 3.75 | 67.4 | 12 | 26.3 | 81.9 | 76.0 |
| MATCH | 61DAA | 6 | 3.2 | 3.75 | 67.4 | 12 | 26.3 | 82.5 | 76.7 |
| MATCH | 61DAA | 4.8 | 0.0 | 3.75 | 67.4 | 9.6 | 23.7 | 82.5 | 75.1 |
| MATCH | 61DAA | 6 | 3.2 | 3.75 | 67.4 | 9.6 | 23.7 | 81.9 | 75.9 |
| STEME | 61DAA | 4.8 | 0.0 | 3.75 | 68.8 | 12 | 3.8 | 98.8 | 69.9 |
| STEME | 61DAA | 6 | 1.3 | 3.75 | 68.8 | 12 | 3.8 | 98.3 | 70.2 |
| STEME | 61DAA | 4.8 | 0.0 | 3.75 | 68.8 | 9.6 | 5.0 | 99.8 | 70.4 |
| STEME | 61DAA | 6 | 1.3 | 3.75 | 68.8 | 9.6 | 5.0 | 98.3 | 70.7 |
| STEME | 61DAA | 4.8 | 0.0 | 3.75 | 56.1 | 12 | 9.7 | 84.5 | 60.4 |
| STEME | 61DAA | 6 | 3.2 | 3.75 | 56.1 | 12 | 9.7 | 84.7 | 61.5 |
| STEME | 61DAA | 4.8 | 0.0 | 3.75 | 56.1 | 9.6 | 11.1 | 88.6 | 61.0 |
| STEME | 61DAA | 6 | 3.2 | 3.75 | 56.1 | 9.6 | 11.1 | 83.9 | 62.2 |
| CENCY | 77DAA | 3 | 82.5 | 3 | 40.0 | 12 | 15.0 | 99.5 | 91.3 |
| CENCY | 77DAA | 3 | 82.5 | 4 | 82.5 | 12 | 15.0 | 99.8 | 97.5 |
| MATCH | 78DAA | 4.8 | 6.3 | 3.75 | 76.3 | 12 | 18.8 | 98.8 | 81.5 |
| MATCH | 78DAA | 6 | 6.3 | 3.75 | 76.3 | 12 | 18.8 | 98.8 | 81.5 |
| MATCH | 78DAA | 4.8 | 6.3 | 3.75 | 76.3 | 9.6 | 17.0 | 98.8 | 81.4 |
| MATCH | 78DAA | 6 | 6.3 | 3.75 | 76.3 | 9.6 | 17.0 | 98.8 | 81.4 |
| STEME | 78DAA | 4.8 | 6.3 | 3.75 | 31.3 | 12 | 13.8 | 98.8 | 44.6 |
| STEME | 78DAA | 6 | 8.8 | 3.75 | 31.3 | 12 | 13.8 | 98.5 | 46.2 |
| STEME | 78DAA | 4.8 | 6.3 | 3.75 | 31.3 | 9.6 | 16.3 | 99.0 | 46.2 |
| STEME | 78DAA | 6 | 8.8 | 3.75 | 31.3 | 9.6 | 16.3 | 98.3 | 47.8 |
| CENCY | 84DAA | 3 | 1.3 | 4 | 30.0 | 12 | 12.5 | 62.5 | 39.2 |
| CENCY | 84DAA | 4 | 27.5 | 4 | 30.0 | 12 | 12.5 | 71.3 | 55.5 |
| CNSRE | 84DAA | 3 | 70.0 | 3 | 79.0 | 12 | 70.0 | 100.0 | 98.1 |
| CNSRE | 84DAA | 3 | 70.0 | 4 | 80.0 | 12 | 70.0 | 100.0 | 98.2 |
| CNSRE | 84DAA | 4 | 72.5 | 3 | 79 | 12 | 70 | 100 | 98.3 |
| CNSRE | 84DAA | 4 | 72.5 | 4 | 80 | 12 | 70 | 100 | 98.4 |

TABLE 3
Herbicidal Grass Weed Control (% Visual Control) from Three-Way Tank
Mixtures of Halauxifen-Methyl + Florasulam + Pyroxsulam
in Multiple Field Trials at 14 to 56 Days After Application (DAA).

| | | | | | | | | Combination | |
|---|---|---|---|---|---|---|---|---|---|
| | | Halauxifen- | | | | | | | Colby |
| | | Methyl | | Florasulam | | Pyroxsulam | | Observed | Predicted |
| Weed | | | Mean % | | Mean % | | Mean % | Mean % | Mean % |
| Bayer | Evaluation | | Weed | | Weed | | Weed | Weed | Weed |
| Code | Interval | g ae/ha | Control | g ai/ha | Control | g ai/ha | Control | Control | Control |
| AGRRE | 14DAA | 3 | 0.0 | 4 | 0.0 | 12 | 37.5 | 78.8 | 37.5 |
| ALOMY | 15DAA | 4 | 0.0 | 3 | 2.5 | 12 | 27.5 | 55.0 | 28.8 |
| APESV | 14DAA | 3 | 0.0 | 3 | 0.0 | 12 | 72.5 | 91.3 | 72.5 |
| APESV | 14DAA | 3 | 0.0 | 4 | 0.0 | 12 | 72.5 | 90.8 | 72.5 |
| APESV | 14DAA | 4 | 0.0 | 3 | 0.0 | 12 | 72.5 | 90.8 | 72.5 |
| APESV | 14DAA | 4 | 0.0 | 4 | 0.0 | 12 | 72.5 | 92.0 | 72.5 |
| APESV | 28DAA | 3 | 0.0 | 3 | 0.0 | 12 | 88.8 | 99.5 | 88.8 |
| APESV | 28DAA | 3 | 0.0 | 4 | 0.0 | 12 | 88.8 | 96.3 | 88.8 |
| APESV | 28DAA | 4 | 0.0 | 3 | 0.0 | 12 | 88.8 | 96.3 | 88.8 |
| APESV | 28DAA | 4 | 0.0 | 4 | 0.0 | 12 | 88.8 | 98.8 | 88.8 |
| APESV | 56DAA | 3 | 0.0 | 3 | 0.0 | 12 | 94.5 | 100.0 | 94.5 |
| APESV | 56DAA | 3 | 0.0 | 4 | 0.0 | 12 | 94.5 | 98.8 | 94.5 |
| ECHCG | 14DAA | 3 | 0.0 | 6.25 | 20.0 | 18.75 | 85.0 | 90.0 | 88.0 |
| ECHCG | 29DAA | 3 | 0.0 | 6.25 | 10.0 | 18.75 | 75.0 | 80.0 | 77.5 |
| ECHCG | 56DAA | 3 | 0.0 | 6.25 | 10.0 | 18.75 | 60.0 | 75.0 | 64.0 |

TABLE 4
Herbicidal Grass and Broadleaf Weed Control (% Visual
Control) from Two-Way Tank Mixtures of Halauxifen-
Methyl + Florasulam and Pyroxsulam in Multiple
Field Trials at 14 to 78 Days After Application (DAA).

| | | | | | | Combination | |
|---|---|---|---|---|---|---|---|
| | | Halauxifen- | | | | | Colby |
| | | Methyl + | | Pyroxsulam | | Meas- | Pre- |
| | | Florasulam | | | Mean | ured | dicted |
| Weed | Eval- | | Mean % | | % | Mean % | Mean % |
| Bayer | uation | | Weed | g | Weed | Weed | Weed |
| Code | Interval | g ai/ha | Control | ai/ha | Control | Control | Control |
| LOLSS | 14DAA | 10 | 0.0 | 18.75 | 90.0 | 92.8 | 90.0 |
| LAMPU | 15DAA | 9.75 | 72.5 | 12 | 10.0 | 95.0 | 75.3 |
| LAMPU | 15DAA | 9.75 | 72.5 | 9.6 | 16.3 | 95.0 | 76.9 |
| STEME | 15DAA | 8.55 | 23.8 | 9.6 | 0.0 | 32.5 | 23.8 |
| LOLMU | 28DAA | 10.5 | 0.0 | 22.5 | 72.5 | 82.5 | 72.5 |
| LOLRI | 28DAA | 8 | 0.0 | 22.5 | 72.5 | 92.5 | 72.5 |
| SOLNI | 29DAA | 9.25 | 40.0 | 18.75 | 50.0 | 90.0 | 70.0 |
| AVEST | 32DAA | 10 | 0.0 | 18.75 | 97.8 | 100.0 | 97.8 |
| LAMPU | 32DAA | 9.75 | 95.3 | 9.6 | 0.0 | 96.3 | 95.3 |
| LOLMU | 55DAA | 10.5 | 0.0 | 22.5 | 72.5 | 85.0 | 72.5 |
| LOLMU | 55DAA | 8.75 | 0.0 | 22.5 | 72.5 | 85.0 | 72.5 |
| PAPRH | 56DAA | 8.75 | 98.8 | 22.5 | 1.9 | 100.0 | 98.8 |
| SOLNI | 56DAA | 9.25 | 30.0 | 18.75 | 30.0 | 90.0 | 51.0 |
| AVESS | 76DAA | 11 | 2.5 | 18.75 | 62.0 | 91.5 | 63.1 |
| STEME | 78DAA | 8.55 | 98.0 | 9.6 | 16.3 | 99.0 | 98.3 |

The following abbreviations are used in the tables above:

halauxifen-methyl=methyl ester of 4-amino-3-chloro-6-(4-chloro-2-fluoro-3-methoxyphenyl)pyridine-2-carboxylic acid or methyl 4-amino-3-chloro-6-(4-chloro-2-fluoro-3-methoxyphenyl)pyridine-2-carboxylate
florasulam=N-(2,6-difluorophenyl)-8-fluoro-5-methoxy[1,2,4]triazolo [1,5-c]pyrimidine-2-sulfonamide

pyroxsulam=N-(5,7-dimethoxy[1,2,4]triazolo[1,5-a]pyrimidin-2-yl)-2-methoxy-4-(trifluoromethyl)-pyridine-3-sulfonamide

AGRRE=Agropyron repens L. (quackgrass)
ALOMY=Alopecurus myosuroides Huds. (blackgrass)
APESV=Apera spica-venti (L.) Beauv. (windgrass)
AVESS=Avena sp. (oats)
AVEST=Avena macrocarpa Moench (wild red oat)
CENCY=Centaurea cyanus (cornflower)
CNSRE=Consolida regalis S. F. Gray (branching larkspur)
ECHCG=Echinochloa crus-galli (L.) P. Beauv. (barnyardgrass)
GALAP=Galium aparine L. (catchweed bedstraw)
LAMPU=Lamium purpureum L. (purple deadnettle)
LOLMU=Lolium multiflorum Lam. (Italian ryegrass)
LOLRI=Lolium rigidum (rigid ryegrass)
LOLSS=Lolium L. sp. (ryegrass)
MATCH=Matricaria recutita L. (wild chamomile)
MATIN=Matricaria inodora (scentless mayweed)
PAPRH=Papaver rhoeas L. (common poppy)
SOLNI=Solanum nigrum L. (black nightshade)
STEME=Stellaria media (L.) Vill. (common chickweed)
VIOAR=Viola arvensis Murr. (field violet)
g ae/ha=grams acid equivalent per hectare
g ai/ha=grams active ingredient per hectare

### DAA=Days After Application

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative composition materials and method steps disclosed herein are specifically described, other combinations of the composition materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed.

What is claimed is:

1. A herbicidal tank mix composition comprising a herbicidally effective amount of:
(a) a compound of the formula (I) 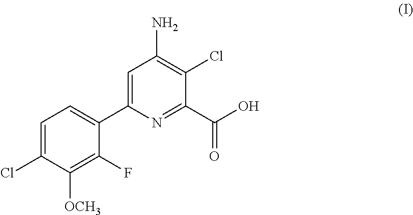 [SMILES: COc1c(Cl)ccc(-c2cc(N)c(Cl)c(C(=O)O)n2)c1F]
or an agriculturally acceptable salt or ester thereof, (b) florasulam or an agriculturally acceptable salt thereof, and (c) pyroxsulam or an agriculturally acceptable salt thereof.

2. The composition of claim 1, wherein (a) is a C₁-C₄ alkyl or benzyl ester of compound (I).

3. The composition of claim 3, wherein (a) is a methyl ester of compound (I).

4. The composition of claim 1, wherein (a) is the carboxylic acid of formula (I).

5. The composition of claim 1, wherein (a) is the methyl ester of the compound of formula (I) and (b) is florasulam.

6. The composition of any of claims 1-5, wherein the weight ratio of (a)+(b) to (c) is from about 1:100 to about 100:1.

7. The composition of claim 6, wherein the weight ratio of (a)+(b) to (c) is from about from about 1:12.5 to about 12.5:1

8. The composition of claim 7, wherein the weight ratio of (a)+(b) to (c) is from about 1:3.1 to about 1.5:1.

9. The composition of any of claims 1-5, wherein the weight ratio of (a) to (b) to (c) is from about 1-80 of (a) to about 1-120 of (b) to about 1-200 of (c).

10. The composition of claim 9, wherein the weight ratio of (a) to (b) to (c) is from about 1-10 of (a) to about 1-15 of (b) to about 1-25 of (c).

11. The composition of claim 10, wherein the weight ratio of (a) to (b) to (c) is from about 1-2 of (a) to about 1-2.1 of (b) to about 1-4 of (c).

12. The composition of any of claims 1-11, further comprising a herbicidally effective amount of an additional herbicide.

13. The composition of claim 12, wherein the additional herbicide is amidosulfuron, aminopyralid, benfluralin, bicyclopyrone, bifenox, bromoxynil, carfentrazone, carfentrazone-ethyl, chlorotoluron, chlorsulfuron, cinidon, cinidon-ethyl, clodinafop-propargyl, clopyralid, difenzoquat, diflufenican, ethalfluralin, fenoxaprop, fenoxaprop-P-ethyl, fenoxaprop-P-ethyl+isoxadifen-ethyl, flucarbazone, flufenacet, flumetsulam, flumioxazin, fluoroglycofen, flupyrsulfuron, fluroxypyr, flurtamone, fluthiacet, glufosinate, glyphosate, imazamethabenz, imazamox, indanofan, indaziflam, iodosulfuron, iodosulfuron-ethyl-sodium, ioxynil, isoproturon, isoxaben, MCPA esters and amines, MCPA-thioethyl, MCPB, mecoprop, mecoprop-P, mesosulfuron, metosulam, metribuzin, metsulfuron, metsulfuron-methyl, oxyfluorfen, paraflufen-ethyl, paraquat, pendimethalin, penoxsulam, picloram, picolinafen, pinoxaden, propoxycarbazone, propyzamide, prosulfocarb, pyraflufen, pyraflufen-ethyl, pyrasulfotole, pyroxasulfone, rimsulfuron, saflufenacil, sulfosulfuron, thiencarbazone-methyl, thifensulfuron, thifensulfuron-methyl, topramezone, tralkoxydim, tri-allate, triasulfuron, tribenuron, tribenuron-methyl, triclopyr, triclopyr choline salt, triclopyr esters and salts, trifluralin, tritosulfuron, benzyl 4-amino-3-chloro-5-fluoro-6-(4-chloro-2-fluoro-3-methoxyphenyl)pyridine-2-carboxylate, and salts, choline salts, esters, optically active isomers and mixtures thereof.

14. The composition of any of claims 1-13, further comprising a herbicide safener.

15. The composition of claim 14, wherein the herbicide safener is cloquintocet (mexyl).

16. The composition of any of claims 1-15, further comprising an agriculturally acceptable adjuvant.

17. The composition of any of claims 1-16, wherein the composition is synergistic or exhibits synergy as determined by the Colby equation.

18. A method of controlling undesirable vegetation comprising contacting undesirable vegetation or the locus thereof, or foliage, water or soil, with the composition of any of claims 1-17.

19. The method of claim 18, wherein the composition is applied post-emergence to the undesirable vegetation.

20. The method of claim 18, wherein the composition is applied pre-emergence to the undesirable vegetation.

21. The method of claim 18, wherein the undesirable vegetation is contacted prior to planting a crop.

22. The method of any of claims 18-21, wherein the weight ratio of (a)+(b) to (c) is from about 1:100 to about 100:1.

23. The method of claim 22, wherein the weight ratio of (a)+(b) to (c) is from about 1:12.5 to about 12.5:1.

24. The method of claim 23, wherein the weight ratio of (a)+(b) to (c) is from about 1:3.1 to about 1.5:1.

25. The method of any of claims 18-21, wherein the weight ratio of (a) to (b) to (c) is from about 1-80 of (a) to about 1-120 of (b) to about 1-200 of (c).

26. The method of claim 25, wherein the weight ratio of (a) to (b) to (c) is from about 1-10 of (a) to about 1-15 of (b) to about 1-25 of (c).

27. The method of claim 26, wherein the weight ratio of (a) to (b) to (c) is from about 1-2 of (a) to about 1-2.1 of (b) to about 1-4 of (c).

28. The method of any of claims 18-27, further comprising contacting the undesirable vegetation with a herbicidally effective amount of an additional herbicide.

29. The method of claim 28, wherein the additional herbicide is amidosulfuron, aminopyralid, benfluralin, bicyclopyrone, bifenox, bromoxynil, carfentrazone, carfentrazone-ethyl, chlorotoluron, chlorsulfuron, cinidon, cinidon-ethyl, clodinafop-propargyl, clopyralid, difenzoquat, diflufenican, ethalfluralin, fenoxaprop, fenoxaprop-P-ethyl, fenoxaprop-P-ethyl+isoxadifen-ethyl, flucarbazone, flufenacet, flumetsulam, flumioxazin, fluoroglycofen, flupyrsulfuron, fluroxypyr, flurtamone, fluthiacet, glufosinate, glyphosate, imazamethabenz, imazamox, indanofan, indaziflam, iodosulfuron, iodosulfuron-ethyl-sodium, ioxynil, isoproturon, isoxaben, MCPA esters and amines, MCPA-thioethyl, MCPB, mecoprop, mecoprop-P, mesosulfuron, metosulam, metribuzin, metsulfuron, metsulfuron-methyl, oxyfluorfen, paraflufen-ethyl, paraquat, pendimethalin, penoxsulam, picloram, picolinafen, pinoxaden, propoxycarbazone, propyzamide, prosulfocarb, pyraflufen, pyraflufen-ethyl, pyrasulfotole, pyroxasulfone, rimsulfuron, saflufenacil, sulfosulfuron, thiencarbazone-methyl, thifensulfuron, thifensulfuron-methyl, topramezone, tralkoxydim, tri-allate, triasulfuron, tribenuron, tribenuron-methyl, triclopyr, triclopyr choline salt, triclopyr esters and salts, trifluralin, tritosulfuron, benzyl 4-amino-3-chloro-5-fluoro-6-(4-chloro-2-fluoro-3-methoxyphenyl)pyridine-2-carboxylate, and salts, choline salts, esters, optically active isomers and mixtures thereof.

30. The method of any of claims 18-29, wherein (a), (b) and/or (c) are applied simultaneously.

31. The method of any of claims 18-29, wherein (a), (b) and/or (c) are applied sequentially.

32. The method of any of claims 18-31, wherein synergy is determined by the Colby equation.

33. The method of any one of claims 18-32 wherein the undesirable vegetation is controlled in a crop that is tolerant to glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, or bromoxynil.

34. The method of claim 33, wherein the tolerant crop possesses single or multiple or stacked traits conferring tolerance to single or multiple herbicides or single or multiple modes of action.

35. The method of any of claims 18-34, wherein the undesirable vegetation comprises a herbicide resistant or tolerant weed.

36. The method of claim 35, wherein the resistant or tolerant weed is a biotype with resistance or tolerance to single or multiple herbicides or single or multiple chemical classes, or inhibitors of single or multiple herbicide modes of action.

37. The method of claim 36, wherein the resistant or tolerant weed is a biotype resistant or tolerant to synthetic auxins (2,4-D, dicamba, MCPA), pyridyloxy auxins, acetolactate synthase (ALS) or acetohydroxy acid synthase (AHAS) inhibitors, photosystem II inhibitors, acetyl CoA carboxylase (ACCase) inhibitors, photosystem I inhibitors, 5-enolpyruvyl-shikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes of action, quinclorac, arylaminopropionic acids, difenzoquat, endothall or organoarsenicals.

38. The method of any of claims 18-37, wherein the undesirable vegetation is controlled in annual crop, non-crop, cereal crop, IVM, range and pasture, tree and vine crops, perennial crop, fruiting crop, or plantation crop areas, comprising contacting undesirable vegetation or the locus thereof, or water or soil, in annual crop, non-crop, cereal crop, IVM, range and pasture, tree and vine crop, perennial crop, fruiting crop, or plantation crop areas.

39. The method of claim 38, wherein the undesirable vegetation is in an annual crop area and the annual crop area is selected from soybean, corn, cotton, fallow-bed, canola/oilseed rape, sunflower, sorghum, and cereals (wheat, barley, rice, oats, rye, teff and triticale).

40. The method of claim 38, wherein the undesirable vegetation is in a non-crop area and the non-crop area is a pasture, grassland, rangeland, fallowland, fencerow, parking area, tank farm, storage area, rights-of-way, utility area, turf, forestry, aquatics, industrial vegetation management (IVM) or fallow-bed.

41. The method of claim 38 wherein the undesirable vegetation is in a cereal crop area and the foliage of the cereal crop is not contacted when the undesirable vegetation is contacted.

42. The method of claim 41, wherein the cereal crop is selected from rice, wheat, teff, triticale, barley, oats, rye, sorghum, corn/maize and fallow-bed.

43. The method of claim 38, wherein the undesirable vegetation is in a perennial crop area and the foliage of the perennial crop is not contacted when the undesirable vegetation is contacted.

44. The method of claim 43, wherein the perennial crop is a tree and vine orchard.

45. The method of claim 44, wherein the tree and vine orchard is selected from citrus, grapes, almond, apple, apricot, avocado, banana, beechnut, Brazil nut, butternut, cashew, cherry, chestnut, chinquapin, crab apple, date, feijoa, fig, filbert, hickory nut, kiwi, lemon, lime, loquat, macadamia nut, mandarin, mango, mayhaws, oranges, nectarine, olives, peach, pear, pecan, persimmon, pistachio, plum, pomegranate, prune, quince, tree nut and walnut.

46. The method of claim 38, wherein the undesirable vegetation is in a fruiting crop area and the foliage of the fruiting crop is not contacted when the undesirable vegetation is contacted.

47. The method of claim 46, wherein fruiting crop is selected from blueberries, guava, papaya, strawberries, taro, blackberries, pineapple, and raspberries.

48. The method of claim 38, wherein the undesirable vegetation is in a plantation crop area and the foliage of the plantation crop is not contacted when the undesirable vegetation is contacted.
The method of claim 48, wherein plantation crop is selected from coffee, cacao, rubber and palm oil.
